(19) United States
(12) Patent Application Publication
(10) Pub. No.: US 2015/0341241 A1
(43) Pub. Date: Nov. 26, 2015

(54) METHOD AND APPARATUS FOR SPECIFYING MACHINE IDENTIFIERS FOR MACHINE-TO-MACHINE PLATFORM SUPPORT

(71) Applicant: VERIZON PATENT AND LICENSING INC., Arlington, VA (US)

(72) Inventor: Daniel J. ROBERTSON, White Plains, NY (US)

(73) Assignee: VERIZON PATENT AND LICENSING INC., Arlington, VA (US)

(21) Appl. No.: 14/286,521

(22) Filed: May 23, 2014

(51) Int. Cl. H04L 12/26; H04L 29/08; H04L 29/06

(52) U.S. Cl. CPC H04L 43/0811; H04L 63/10; H04L 67/18

(57) ABSTRACT

An approach is provided for determining, specifying, or associating a unique identifier with a machine in a machine-to-machine communications network. The approach includes specifying a unique identifier for a machine attached to a sub-network of an aggregator, wherein the machine and the aggregator comprise at least a portion of a machine-to-machine deployment. The approach also includes associating the unique identifier with a message directed to or originating from the machine via the aggregator, wherein the unique identifier is exposed beyond the sub-network for determining a connectivity status of the machine.

### BACKGROUND INFORMATION

With technological advances in available electronic devices, various applications and service providers can provide useful and efficient functionalities at the devices. One area of interest has been developments in machine-to-machine (M2M) communications, where various devices/machines can conduct inter-machine communications that would require no human intervention. In various scenarios, M2M communications have been utilized in smart metering (e.g., in electricity metering, automobiles, etc.), retail (e.g., vending machines), healthcare, telematics, and other instances where information is communicated between the machines, sensors and other entities in a communications network/system. In some instances, an M2M platform may be utilized to monitor or manage the communication, connectivity, or resource utilization of the machines deployed in the communication network. Also, in some instances, a plurality of the machines may be connected to a sub-network aggregator, which in turn may be connected to the communications network or to the M2M platform.

Based on the foregoing, there is a need for determining, specifying, or associating a unique identifier with a machine in an M2M communications network.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of determining, specifying, or associating a unique identifier with a machine in a machine-to-machine communications network, according to one embodiment;

FIG. 2 is a diagram of the components of a machine-to-machine platform, according to one embodiment;

FIG. 3 is a diagram of the components of a machine, according to one embodiment;

FIGS. 4 through 6 are flowcharts of processes for determining, specifying, or associating a unique identifier with a machine in a machine-to-machine communications network, according to various embodiments;

FIGS. 7A through 7D illustrate example communication messages in a machine-to-machine communications network, according to various embodiments;

FIG. 8 is a diagram of a computer system that can be used to implement various exemplary embodiments; and

FIG. 9 is a diagram of a chip set that can be used to implement an embodiment of the invention.

### DESCRIPTION OF THE PREFERRED EMBODIMENT

An apparatus, method and software for determining, specifying, or associating a unique identifier (ID) with a device/machine in an M2M communications network are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although the various exemplary embodiments are described for determining, specifying, or associating a unique ID with a device in an M2M communications network, it is contemplated that these embodiments have applicability to a variety of devices, applications, or services where various functionalities or information associated with a device in a network may be monitored, queried, or managed by one or more entities in the network.

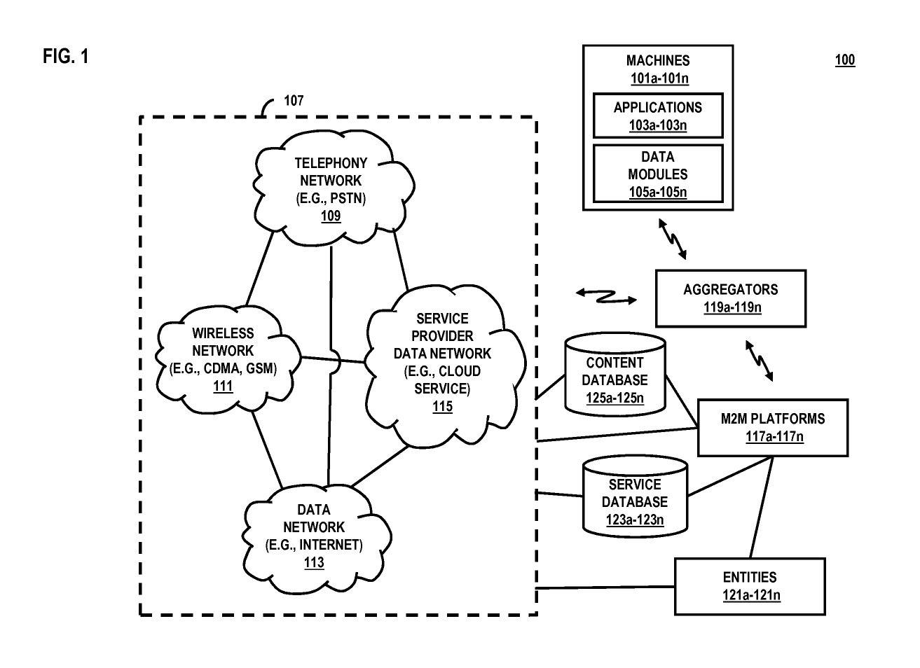

FIG. 1 is a diagram of a system for determining, specifying, or associating a unique ID with a machine in an M2M communications network. Traditionally, M2M communications refer to inter-machine communications where human intervention may be unnecessary or minimal, and where an M2M platform may be utilized. In one scenario, an M2M platform may refer to an entity utilized for tracking, monitoring, or managing of connectivity or resource utilization of deployed machines over one or more communication networks; for example, wireless/wireline local/wide area (e.g., cellular, WiMAX, cable, etc.) networks. In some instances, an M2M platform may provide various functionalities for centrally managing a distributed deployment of M2M devices that may be connected to or implemented in the machines; for example, in utility meters (e.g., electricity, water, gas, etc.), vending machines (e.g., a soda/snack machine), automobiles (e.g., a delivery truck, a taxicab, etc.), sensors, power generators, demand management, smart appliances, isolated micro-grids, storage, or the like. Further, the machines may be connected via a communications network to one or more backend enterprise systems (e.g., one or more companies related to the machines/devices.) In some implementations, the M2M platforms may provide support for managing connectivity (e.g., activate, suspend, deactivate, connection status, a loss of connection warning, diagnostics, etc.), billing (e.g., change data plans, current balance/utilization, expense management, over usage detection warning, etc.), queries (e.g., for reports/records), or the like activities that may be associated with a device. As a result, for efficient operations and management of the deployed devices/machines (e.g., in remote deployments), an M2M platform can provide capabilities and services that can be an indispensable asset to entities associated with the devices.

In some use cases, M2M deployment topologies may utilize an aggregator or a concentrator to provide a connectivity link (e.g., wireless or wireline) between a local area sub-network of machines and a wide area communications network. However, since an M2M platform may not have direct visibility or communication access to machines in the sub-network of an aggregator, the M2M platform may not be able to efficiently monitor or manage those machines. Such limitation, for example, could mean that if a machine loses connectivity to the sub-network, either due to a fault or some malicious intent, the M2M platform may not be able to detect or initiate an appropriate process to address the issue. Therefore, there is a need for determining, specifying, or associating a unique ID with a device/machine in an M2M communications network.

To address these issues, system 100 of FIG. 1 provides the capability for determining, specifying, or associating a unique ID with a device/machine in an M2M communications network. In some implementations, several tens, hundreds, or even thousands of machines can be served by a single aggregator unit, wherein this approach could provide for significant benefits such as improved coverage, network efficiency, and reduced operational costs. As noted, such an approach does not provide detailed information about the individual machines to the M2M platform. However, if the machines are associated with unique IDs and if the M2M platform is aware of those IDs, then information, queries, commands, etc. for each machine can be identified and communicated to or from each machine.

In one embodiment, functionalities of an M2M platform may be enhanced by determining, specifying, or associating a unique ID with a device in an M2M communications network. In one scenario, connection or functionality status of existing or subsequently introduced devices that are attached to an aggregator sub-network can be determined by an M2M platform or by other elements of a communications network associated with the aggregator. In one use case, an M2M platform may identify an issue from the status information of a machine, where the status information or details of the issue may be presented to one or more entities (e.g., a backend system) that are associated with the machine. Further, the M2M platform or the entities can determine and initiate one or more steps or processes to address the identified issue.

In one embodiment, an M2M platform can process solicited or unsolicited messages from an aggregator, or another network element, wherein the messages may contain unique IDs and status information of devices connected to the aggregator. For example, an aggregator message can include the unique ID of a vending machine and status information about the vending machine's operational status (e.g., malfunctioning, potentially needed repairs, etc.), available resources (e.g., an inventory of remaining products/services), or the like information.

In various embodiments, an M2M platform can determine, from messages to or from a deployed machine, additional information to generate a register of data about the deployed machine's geographic location, description information, service history information, status log, or the like data. In various use cases, the register data may be utilized to aid with management, remediation, predictive analytics, or diagnostics processes of any emerging trends, e.g., possible fraudulent activities associated with data in particular status changes.

For the purpose of illustration, the system 100 may include one or more machines 101a-101n (machine or device 101), which may include, execute, or utilize one or more applications 103a-103n (applications 103) and one or more data collection modules 105a-105n (data module 105).

Furthermore, the system 100 may include a network system 107, which may include one or more networks, including a telephony network 109, a wireless network 111, a data network 113, a service provider data network 115, or the like system elements. By way of example, the networks 109, 111, 113, and 115 may be any suitable wireline and/or wireless network, which may be managed by one or more service providers. In one example, the networks 109, 111, 113, and 115 may be one or more elements in the network system 107, which may include various components and elements for providing a range of communication and network services. For example, telephony network 109 may include a circuit-switched network, such as the public switched telephone network (PSTN), an integrated services digital network (ISDN), a private branch exchange (PBX), or other like network. Wireless network 111 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 113 may be any local area network (LAN), metropolitan area network (MAN), wide area network (WAN), the Internet, or any other suitable packet-switched network, such as a commercially owned, proprietary packet-switched network, such as a proprietary cable or fiber-optic network. By way of example, a service provider 115 may provide any number of services (e.g., mapping services, social networking services, media services, content services, device management services, etc.) via a web server or other means of communications (e.g., text messaging, voice, instant messaging, chat, etc.)

Additionally, the system 100 may include one or more machine-to-machine platforms 117a-117n (M2M platform 117 or M2M platform), which may be implemented as a standalone or as an integrated component of a service or a content provider in the network system 107 for providing support in M2M management or monitoring of the machines 101 in the system 100.

Further, the system 100 may include one or more aggregators 119a-119n (aggregator 119 or aggregator), which may implemented as a local or as a remote point of service element (e.g., a router) to provide a connectivity link (e.g., wireless or wireline) between a local area sub-network of machines 101 and a wide area communications network, for example, the wireless network 111.

In one example, an M2M platform may interface with or provide one or more services to one or more entities 121a-121n (entity 121 or entity) that may be associated with the machines 101 or with the aggregators 119. For example, an entity may include an owner, a user, an enterprise, or the like that may have a controlling interest over the machines 101 or the aggregators 119. In various scenarios, an entity associated with one or more machines 101 may provide an M2M platform with guidelines, policies, directives, or the like information, which may be utilized to manage the associated machines 101.

Although depicted as separate entities, the networks 109, 111, 113, and 115, and the M2M platform 117 or the aggregators 119 may be completely or partially contained within one another, or may embody one or more of the aforementioned infrastructures. For instance, the service provider network 115 may embody circuit-switched and/or packet-switched networks that include facilities to provide for transport of circuit-switched and/or packet-based communications. It is further contemplated that networks 109, 111, 113, and 115 may include components and facilities to provide for signaling and/or bearer communications between the various components or facilities of system 100. In this manner, networks 109, 111, 113, and 115 may embody or include portions of a signaling system 7 (SS7) network, or other suitable infrastructure to support control and signaling functions.

In various embodiments, one or more elements of the system 100 may include or have access to one or more service databases 123a-123n (service database 123 or service database), which may include various machine 101 or entity 121 profiles, entity preferences or policies, service providers 115 information, or the like information. In one embodiment, the service provider 115 may include one or more service providers offering one or more services, for example, navigation services, online shopping, social networking services (e.g., blogging), content sharing, media upload, media download, media streaming, account management, or the like services.

In various embodiments, the service provider 115 may include or have access to one or more content databases 125a-125n (content database 125 or content database), which may store, include, or have access to various content items. For example, the service provider 115 may store content items (e.g., at the content database 125) provided by various users, various service providers, crowd-sourced content, or the like.

By way of examples, the machines 101 may communicate with other devices via one or more proximity-based communication channels or via one or more network service providers in the network system 107. Further, the applications 103 may include various applications for productivity, education, entertainment, social networking, web browser, communications, content sharing, multimedia applications, user interface (UI), map application, web client, or the like.

In one embodiment, a machine 101 may utilize a data module 105 for determining/collecting data or content associated with the machine, one or more users of the machine, the applications 103, environment/surroundings of the machine, or the like. In addition, a machine 101 can execute an application 103 that is a software client for storing, processing, and/or forwarding one or more information items to other components of the system 100. In various embodiments, the data module 105 may include various sensors for detecting and capturing various signals, information, and contents, for example, audio, video, location information, Bluetooth signals, near field communication (NFC) signals, wireless local area network (WLAN) signals, RFID signals, or the like. Further, the collected information, content, or signals may be shared, via the applications 103 or the data module 105, with an aggregator 119, other machines 101, or service providers in the network system 107.

It is noted that the machines 101 may be any type of mobile terminal, fixed terminal, or portable terminal that may be a standalone machine or that can be partially or totally implemented in a mobile handset, automobile, station, unit, device, multimedia computer, multimedia tablet, Internet node, communicator, desktop computer, laptop computer, Personal Digital Assistants (PDAs), smartphone, set-top box, TV set, or any combination thereof. It is also contemplated that the machines 101 can support any type of interface for supporting the presentment or exchanging of data. In addition, the machines 101 may facilitate various input means for receiving and generating information, including an M2M interface, touch screen capability, keyboard and keypad data entry, voice-based input mechanisms and the like. Any known and future implementations of machines 101 are applicable. In certain embodiments, the machines 101 may be configured to establish peer-to-peer communication sessions with each other or with an aggregator 119 by using a variety of technologies, including near field communication (NFC), Bluetooth, ZigBee, infrared, etc. Also, connectivity can be provided via a wireless or a wireline local area network (LAN). By way of example, a group of machines 101 may be configured to form a common LAN so that each device can be uniquely identified via any suitable network addressing scheme.

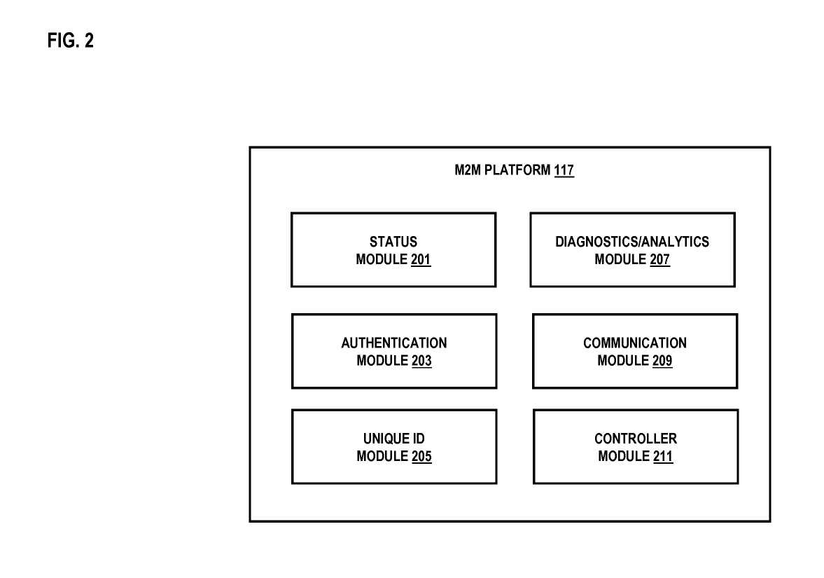

FIG. 2 is a diagram of the components of an M2M platform, according to one embodiment. The M2M platform 117 may include various executable modules for performing one or more computing, data processing or network based instructions that in combination provide a means of determining, specifying, or associating a unique ID with a machine in an M2M communications network. Such modules can be implemented in hardware, firmware, software, or a combination thereof. By way of example, an M2M platform 117 may include a status module 201, an authentication module 203, a unique ID module 205, a diagnostics/analytics module 207, a communication module 209, and a controller module 211. In addition, the M2M platform 117 may include or have access to one or more databases (e.g., databases 123, 125, or the like.)

In one embodiment, a status module 201 may process a communications message to determine status information of a machine in an M2M communication network. In various scenarios, the status module 201 may utilize information in a communications message or in network traffic to determine geographic location information, description information (e.g., a type of machine), service history information (e.g., types, dates, etc.), available resources (e.g., remaining products/services at a machine), or the like that may be associated with the machines attached to a sub-network. In one scenario, an aggregator associated with a machine may provide information in addition to what a machine may determine or report to the aggregator. For example, an aggregator may include, in a communications message, information about other machines which may be interacting with a given machine attached to the aggregator's sub-network.

In one embodiment, an authentication module 203 may authenticate one or more machines 101 that are to be attached to a sub-network associated with an aggregator 119. By way of example, the authentication module 203 may receive or process a request from an entity or an aggregator associated with a sub-network for attaching a new machine to the sub-network. In various scenarios, the request may be received prior to or during a deployment of the new machine. In various examples, the authentication module 203 may have access to a database associated with a sub-network or with the entity associated with the new machine, wherein the database may provide authentication or authorization information.

In one embodiment, the unique ID module 205 may operate in connection with the authentication module 203 and the controller module 211 to specify a unique identifier for a machine that is attached to a sub-network of an aggregator. In one embodiment, the unique ID may be based on one or more information items associated with the machine, the sub-network, an entity associated with the machine, a service associated with the machine, or the like. In various examples, one or more algorithms may be utilized to process the information about a machine's serial number, Internet protocol (IP) address, a type of the machine, service/product associated with the machine, location of the machine, the sub-network or aggregator associated with the machine, an owner of the machine (e.g., an entity associated with the machine), or the like that may be utilized in specifying, determining, or generating the unique ID for the machine. In one example, the unique ID module 205 may determine or provide one or more portions of the information items that can be utilized by another element in the communications network to specify, determine, or generate the unique ID for the machine. Further, the unique ID module 205 may associate the unique identifier with a message directed to or originating from the machine via the aggregator.

In one embodiment, the diagnostics/analytics module 207 may operate in conjunction with the unique ID module 205 and the controller module 211 to analyze information associated with a machine 101 attached to a given sub-network for diagnosing potential issues at the machine or to determine predictive analytics associated with the machine. In various embodiments, the diagnostics/analytics module 207 may utilize various algorithms to analyze the data associated with the machines attached to a sub-network to predict future events or functionalities at the machines, wherein the analysis may be based on past or current data associated with the machines. In one embodiment, the diagnostics/analytics module 207 may access one or more available databases 123 or 125 for determining information that can be used in the diagnostics or in the predictive analytics.

In one embodiment, the communication module 209 may be utilized to communicate with various applications, modules, or components at an M2M platform, an aggregator, a machine 101, an entity associated with an aggregator or a machine, or with one or more entities of a communications network for presenting or receiving information, messages, or the like associated with M2M communications or services. Additionally, the communication module 209 may be utilized to communicate with one or more components of the system 100. In one scenario, the communications may be effectuated via a communication module available at a machine 101 or an aggregator 119. In one embodiment, the communication module 209 may utilize one or more communication channels to communicate one or more messages, unique IDs, command messages, inquiry messages, or the like associated with machines attached to a sub-network. By way of example, the communication module 209 executes various protocols and data sharing techniques for enabling collaborative execution between a machine 101, an aggregator 119, an M2M platform 117, an entity 121, or the like.

In one embodiment, a controller module 211 is configured to operate and effectuate the processes by or at other modules of the M2M platform 117. For example, the controller module 211 may generate the appropriate signals to control the communication module 209 and the unique ID module 205 for facilitating a transmission of the information over the network system 107.

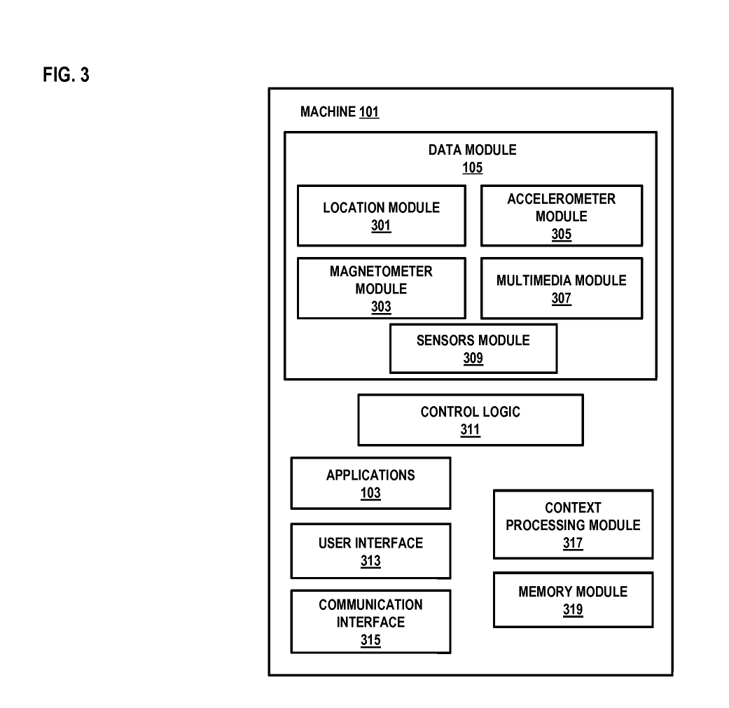

FIG. 3 is a diagram of the components of a machine, according to one embodiment. By way of example, a machine 101 may include one or more components for executing various applications, enabling various functionalities, and for communicating with other machines 101 or with other components of the system 100. It is contemplated that the functions of these components may be combined in one or more components or performed by other components of equivalent functionality. In one embodiment, the machine 101 includes a data module 105, which may include one or more location modules 301, magnetometer modules 303, accelerometer modules 305, multimedia modules 307, and sensors modules 309. Further, the machine 101 may include control logic 311 to coordinate the use of other components of the machine 101, a user interface 313, a communication interface 315, a context processing module 317, and a memory module 319. The applications 103 may execute on the control logic 311 utilizing the components of the machine 101. In various embodiments, the applications 103 may operate in conjunction with one or more modules at a machine 101 for communicating with an aggregator in effectuating a determining, specifying, or an associating of a unique ID with a machine 101 in an M2M communications network.

The location module 301 can determine a location of a machine by a triangulation system such as GPS, assisted GPS (A-GPS), Cell of Origin, or other location extrapolation technologies. Standard GPS and A-GPS systems can use satellites to pinpoint the location of a machine 101. A Cell of Origin system can be used to determine the cellular tower that a cellular device 101 is synchronized with. This information provides a coarse location of the device 101 because the cellular tower can have a unique cellular identifier (cell-ID) that can be geographically mapped. The location module 301 may also utilize multiple technologies to detect the location of the device 101. Location coordinates (e.g., GPS coordinates) can give finer detail as to the location of the device 101 when media is captured. In one embodiment, GPS coordinates are stored as context information in the memory module 319 and are available to the context processing module 317, the data module 105, and/or to other entities of the system 100 (e.g., via the communication interface 315.) Moreover, in certain embodiments, the GPS coordinates can include an altitude to provide a height. In other embodiments, the altitude can be determined using another type of altimeter.

The magnetometer module 303 can be used in finding horizontal orientation of the device 101. A magnetometer is an instrument that can measure the strength and/or direction of a magnetic field. Using the same approach as a compass, the magnetometer is capable of determining the direction of a device 101 using the magnetic field of the Earth. The front of a media capture device (e.g., a camera) can be marked as a reference point in determining direction. Thus, if the magnetic field points north compared to the reference point, then the angle of the device 101 from the magnetic field is known. Simple calculations can be made to determine the direction of the device 101. In one embodiment, horizontal directional data obtained from a magnetometer can be stored in memory module 319, made available to other modules and/or applications 103 of the device 101, and/or transmitted via the communication interface 315 to one or more entities of the system 100. In one embodiment, the applications 103 may utilize the directional data and the location information to determine that a device 101 is moving at a certain rate and at a certain direction.

The accelerometer module 305 can be used to determine vertical orientation of the device 101. An accelerometer is an instrument that can measure acceleration. Using a three-axis accelerometer, with axes X, Y, and Z, provides the acceleration in three directions with known angles. In one embodiment, the front of a media capture device can be marked as a reference point in determining a direction. Because the acceleration due to gravity is known, when a device 101 is stationary, the accelerometer module 305 can determine the angle the device 101 is pointed as compared to Earth's gravity. In certain embodiments, the magnetometer module 303 and the accelerometer module 305 can be utilized for ascertaining a perspective of a device. This perspective information may be stored in the memory module 319, made available to other modules and/or applications 103 of the device 101, and/or communicated to one or more entities of the system 100.

In one embodiment, the multimedia module 307 may be utilized to generate, receive, or consume, etc. various content/media items, for example, images, video, audio, text, and the like. In various embodiments, the media items may be shared with the applications 103, which in turn may share the media with one or more components of the system 100. In various embodiments, the multimedia module 307 may interface with various sensors; for example, a camera, a microphone, etc., to determine additional contextual information associated with device.

In various embodiments, the sensors module 309 can process sensor data from various sensors (e.g., microphone, optical, Bluetooth, NFC, GPS, accelerometer, gyroscope, thermometer, etc.) to determine environmental (e.g., atmospheric) conditions surrounding the device 101, location information, or other information from a range of sensors that may be available on a device 101. For example, the sensors module 309 may detect conditions including humidity, temperature, geo-location, biometric data of a user, or the like information. Once again, this information can be stored in the memory module 319 and sent to the context processing module 317 and/or to other entities of the system 100. In certain embodiments, information collected from the data module 105 can be retrieved by the control logic 311 and stored at the memory module 319, made available to other modules or applications 103 of the device 101, or sent to one or more entities of the system 100. In various embodiments, an audio sensor, an optical sensor, or a motion sensor may be utilized to capture or process various sensor data associated with an environment of the device 101. For example, sensor data captured in or near an automobile may be indicative of present sounds, images, or motions that may have been produced by a driver or nearby equipment. In one scenario, a temperature sensor on device 101 in a truck may notify the M2M platform that the temperature is below or above a certain expected level.

The user interface 313 can include various methods for a user to interface with applications, modules, sensors, and the like at a device 101. For example, the user interface 313 can have outputs including a visual component (e.g., a screen), an audio component, a physical component (e.g., vibrations), and other methods of communication. User inputs can include a touch-screen interface, a scroll-and-click interface, a button interface, a microphone, etc. An input may be via one or more methods such as voice input, textual input, typed input, typed touch-screen input, other touch-enabled input, etc. In one embodiment, the user interface 313 may interact with the applications 103 for determining and presenting a UI and applicable options based on user interactions with the UI elements. In one embodiment, the UI 313 may interact with the applications 103 in order to effectuate a presentation of one or more interaction indicators, interaction options, command messages, or the like at the device 101.

In one embodiment, the communication interface 315 can be used to communicate with one or more entities of the system 100, for example, to submit or receive information associated with the device 101, the M2M platform 117, an entity 121, or the like information. In various embodiments, the communication interface 315 may facilitate communications via one or more wireless communication channels and protocols, for example, WLAN, RFID, NFC, Bluetooth Smart, Bluetooth, Ant+, Z-Wave, ZigBee, or the like, wherein the communication channels may be established via one or more sensors, transceivers, transmitters, receivers, wireless charging interface, or the like. Certain communications can be via methods such as an internet protocol, messaging (e.g., SMS, multimedia messaging service (MMS), etc.), or any other communication method (e.g., via the network system 107). In some examples, the device 101 can send context information associated with the device 101 to other devices 101 or to other entities of the system 100.

The context processing module 317 may be executing on the control logic 311 for determining context information available from the data module 105 or the applications 103. This information may be transmitted, via the communication interface 315, to one or more user devices 101 or to other entities of the system 100. The context processing module 317 may additionally be utilized as a means for determining information related to a user of the device 101, an instance of data, a unique code/ID, a process, a content item, an object, a subject, that an application 103 is being executed, or the like. In certain embodiments, the context processing module 317 can infer higher level context information from the context data such as activity at a device 101, user information of the device 101, information about an environment of the device 101, etc.

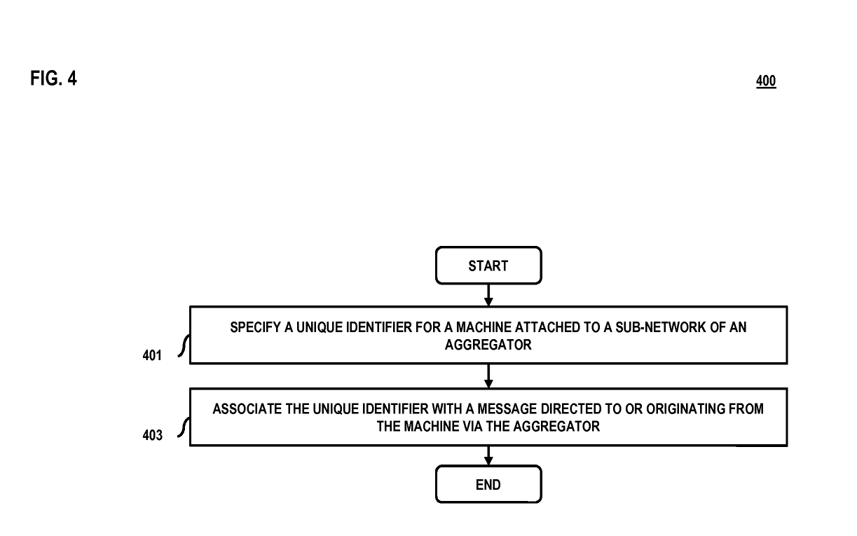

FIGS. 4 through 6 are flowcharts of processes for determining, specifying, or associating a unique ID with a machine in an M2M communications network, according to various embodiments. It is noted that the steps of processes 400, 500, and 600 may be performed in any suitable order as well as combined or separated in any suitable manner. Further, all or portions of the steps or the processes may be initiated or completed by any of the components of the system 100, for example, by an M2M platform 117 or an aggregator 119. However, for clarity in discussing the processes, the M2M platform 117 is referred to as completing various steps of said processes, which may be performed in any suitable order and where one or more of the steps may be optional.

As shown in FIG. 4, the process 400 may begin at step 401 where the M2M platform may specify a unique identifier for a machine attached to a sub-network of an aggregator, wherein the machine and the aggregator comprise at least a portion of a machine-to-machine deployment. In one use case, a plurality of machines (e.g., modules in machines, mobile machines, stationary machines, etc.) may be in communication with an aggregator sub-network where the aggregator provides access to a communications network. For example, several communication modules (e.g., wireless or wireline) in several vending machines, smart electric meters, and automobile charging stations can be connected to a local communications aggregator (e.g., a router, a hub, a gateway, etc.) sub-network, which provides a link to a wide area communications network (e.g., cellular, wireline, etc.) Additionally, an M2M platform may be in communications with the wide area communications network where it can communicate with the machines, the aggregator, or various other elements in communication with the wide area communications network. In one embodiment, the M2M platform may specify a unique ID for each of the machines connected to the aggregator. In one embodiment, the M2M platform may cause or request for another element (e.g., an aggregator) associated with the machines to specify the unique ID for each of the machines connected to the aggregator. In one embodiment, the unique identifier is based on one or more information items associated with the machine, the sub-network, an entity associated with the machine, a service associated with the machine, or a combination thereof. In various examples, information about a machine's serial number, Internet protocol (IP) address, a type of the machine, service/product associated with the machine, location of the machine, the sub-network or aggregator associated with the machine, an owner of the machine (e.g., an entity associated with the machine), or the like may be utilized in specifying, determining, or generating the unique ID for the machine. In one example, the M2M platform may determine or provide one or more portions of the information items that may be utilized by another element in the communications network to specify, determine, or generate the unique ID for the machine.

At step 403, the M2M platform may associate the unique identifier with a message directed to or originating from the machine via the aggregator, wherein the unique identifier is exposed beyond the sub-network for determining a connectivity status of the machine. In one embodiment, an M2M platform may process a message received from a machine (e.g., via an aggregator), determine identity of the machine based on information in the message, and then the M2M platform can associate a unique ID with the machine. In one embodiment, a message originating from a machine may include its unique ID, which may have been associated with the machine by an aggregator or another network element associated with the machine. In one embodiment, an M2M platform may process a message directed to a machine (e.g., received from an entity associated with the machine), determine identity of the machine based on information in the message, and then the M2M platform can associate a unique ID with the machine. In one embodiment, an M2M may request for an aggregator to associate a unique ID with a machine that is attached to a sub-network of the aggregator. In one embodiment, an M2M platform may utilize a unique ID associated with a machine to determine connectivity status of the machine with an aggregator, a communications network, the M2M platform, or with one or more other entities of the communications network.

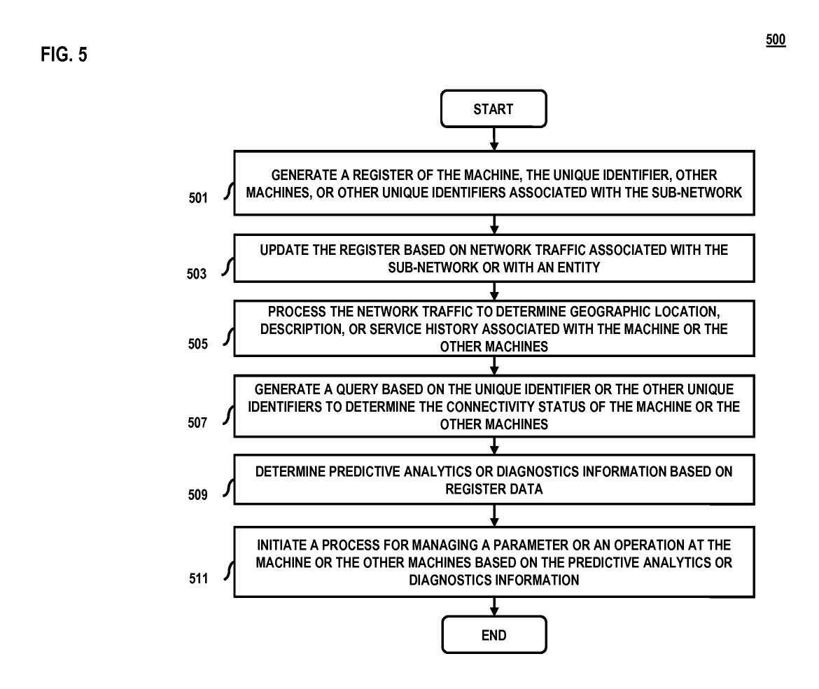

Referring to FIG. 5 now, the process 500 may begin at step 501 where the M2M platform may generate a register of the machine, the unique identifier, one or more other machines, one or more other unique identifiers, or a combination thereof associated with the sub-network. In various embodiments, an M2M platform may generate one or more registers that include data related to one or more machines and their unique IDs, wherein the machines and their unique IDs are associated with a sub-network of an aggregator. For example, a register may include data indicating that several vending machines, security cameras, lighting fixtures, or the like are associated (e.g., in communications) with a specific sub-network of a specific aggregator.

At step 503, the M2M platform may update the register based on network traffic associated with the sub-network or with an entity. In one scenario, an M2M platform may monitor and process network traffic (e.g., communications messages) information from or to various machines in a given sub-network for determining any updates to the register. For example, an update to the register may indicate that one or more machines are no longer in communications with the sub-network. In one embodiment, the network traffic may be from or to one or more entities (e.g., owners, managers, users, etc.) associated with one or more machines in a sub-network of an aggregator. In various scenarios, an update to the register may include any updated information associated with the machines in a sub-network, for example, type of service, resource status, or the like.

At step 505, the M2M platform may process the network traffic to determine geographic location information, description information, service history information, or a combination thereof associated with the machine, the one or more other machines, or a combination thereof. In various scenarios, an M2M platform may utilize information in the network traffic to determine geographic location information, description information (e.g., a type of machine), service history information (e.g., types, dates, etc.), available resources (e.g., remaining products/services at a machine), or the like that may be associated with the machines attached to a sub-network. In one example, location of a moving machine (e.g., a truck) may be determined from network information that is received via a plurality of sub-networks/aggregators.

At step 507, the M2M platform may generate a query based on the unique identifier, the one or more other unique identifiers, or a combination thereof to determine the connectivity status of the machine, the one or more other machines, or a combination thereof. In various scenarios, an M2M platform may generate random or predetermined queries based on a plurality of unique IDs that are associated with a plurality of machines, wherein the queries can be submitted to an aggregator for determining the connectivity status of the machines to the sub-network. In one embodiment, an M2M platform may cause an aggregator of a sub-network to generate the queries to the machines that are attached or are supposed to be attached to the sub-network. For example, a plurality of machines that are to be in communications with the sub-network may have lost connectivity, which may be due to malfunction in the machine or in the aggregator, malicious intervention (e.g., by a user), or the like.

At step 509, the M2M platform may determine predictive analytics or diagnostics information based on register data. In one embodiment, an M2M platform may analyze the register data to determine predictive analytics associated with a machine attached to a given sub-network. For example, various analytical and statistical techniques can be used to analyze the data associated with machines attached to a sub-network and develop models that may be used to predict future events or functionalities at a machine, which may be based on past or current data associated with the machine. The M2M or an entity associated with a machine may utilize the analytics or various data mining techniques and predictive models to determine relationships and trends for predicting potential future events associated with one or more machines attached to a sub-network. For example, based on the predictive analytics of a machine, the M2M platform can potentially foresee an increase or a decrease in resources available at the machine. In one embodiment, the M2M may utilize various diagnostics methods to analyze the register data to determine a current or a possible future service or maintenance that a machine may need. For example, the diagnostics analysis may indicate that a machine is nearing a maintenance schedule or that one or more components at the machine are not functioning properly.

At step 511, the M2M platform may initiate a process for managing a parameter or an operation at the machine, the one or more other machines, or a combination thereof based on the predictive analytics or the diagnostics information. In various embodiments, an M2M platform may determine, from the analytics or the diagnostics associated with a machine, to initiate a process for addressing a current issue or an issue that may need to be addressed in the near future. In various examples, one or more processes may be determined based on a machine type, location of the machine, type of service/product associated with the machine, a policy associated with an entity related to the machine, or the like. In one example, the M2M platform may issue a command to suspend or alter a certain functionality at a machine.

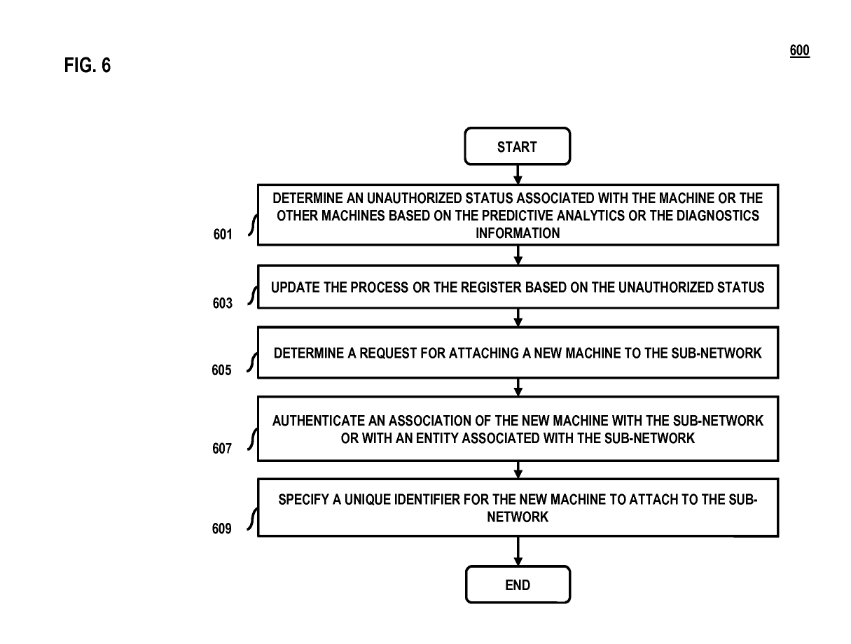

Referring to FIG. 6 now, the process 600 may begin at step 601 where the M2M platform may determine an unauthorized status associated with the machine, the one or more other machines, or a combination thereof based on the predictive analytics or the diagnostics information. In one embodiment, the M2M platform may utilize the results of the predictive analytics or the diagnostics to determine that status information of a machine indicates an unauthorized operation/functionality, location, user interaction, or the like status at the machine. For example, status information of a vending machine may indicate that the machine is providing one or more products or services at an unauthorized discounted rate, at a higher/lower frequency, or the like. In one example, location information of a machine implemented in a delivery truck may indicate that the truck is at an unscheduled location.

At step 603, the M2M platform may update the process or the register based on the unauthorized status. In one scenario, an M2M platform may provide one or more status information items for updating the register data associated with a machine, a sub-network, an aggregator, a unique ID, or the like. In one example, the M2M platform may utilize the one or more status information items to update one or more processed that are to address an issue, an unauthorized status, or the like associated with a machine.

At step 605, the M2M platform may determine a request for attaching a new machine to the sub-network. In one embodiment, an M2M platform may receive a request from an aggregator of a sub-network to attach a new machine to the sub-network. For example, a new utility meter (e.g., a gas meter) may be deployed at a location that is serviced/associated with the sub-network/aggregator and an entity associated with the new meter would like to attach it to the sub-network for communication and M2M services, wherein the aggregator may submit the request to the M2M platform. In one embodiment, an entity associated with the new machine may submit a request for attaching the new machine to a given sub-network. For example, an owner of a new vending machine may submit the request for attaching the new machine to a particular sub-network before the new machine is deployed.

At step 607, the M2M platform may authenticate an association of the new machine with the sub-network or with an entity associated with the sub-network. In one scenario, an M2M platform may authenticate a request for attaching a new machine to a sub-network by requesting an authorization from the aggregator associated with the sub-network. In one embodiment, an M2M platform may request the authorization from an entity (e.g., owner) that may be associated with the sub-network or with the new machine.

At step 609, the M2M platform may specify a unique identifier for the new machine to attach to the sub-network. In one embodiment, an M2M platform may request for or utilize information associated with the new machine and the sub-network to specify a unique ID for attaching the new machine to the sub-network. In one embodiment, the M2M platform may request for an aggregator associated with a sub-network to specify a unique ID for a new machine for attaching the new machine to the sub-network. In various scenarios, information about the new machine and its unique ID may be utilized to update register data associated with a given aggregator, a sub-network, an M2M platform, an entity associated with the new machine, an entity associated with the aggregator or sub-network, or the like.

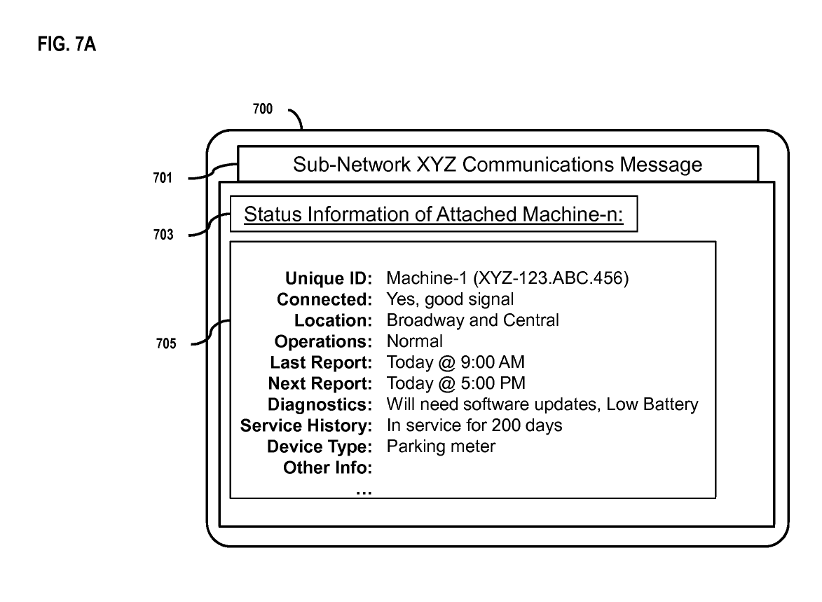

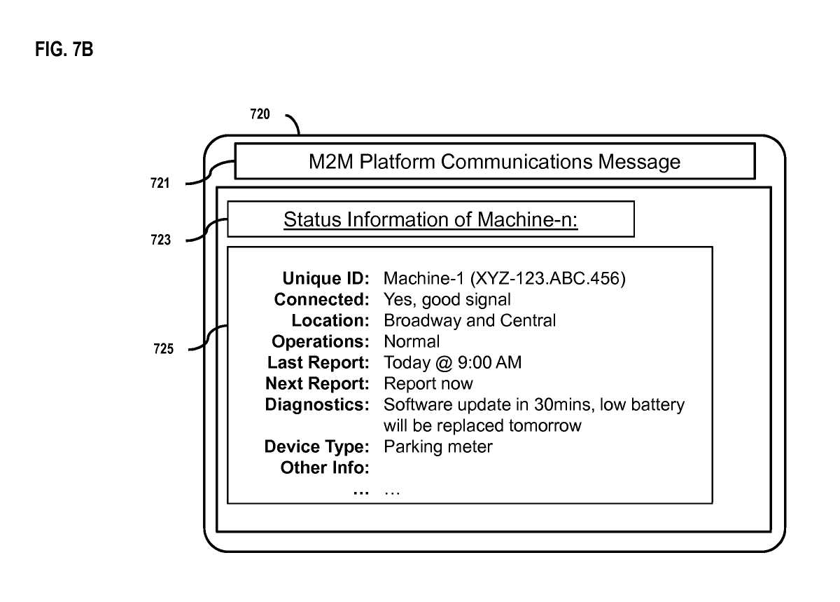

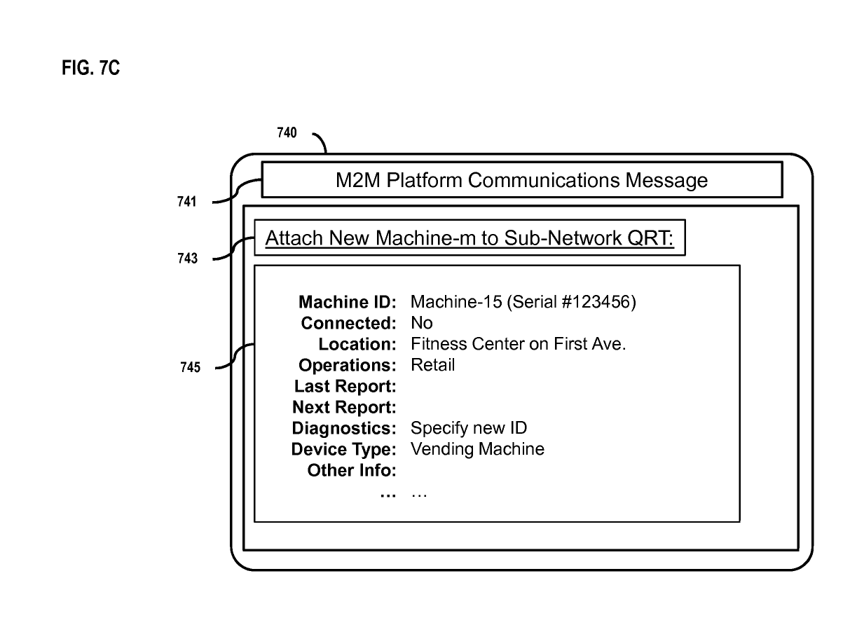

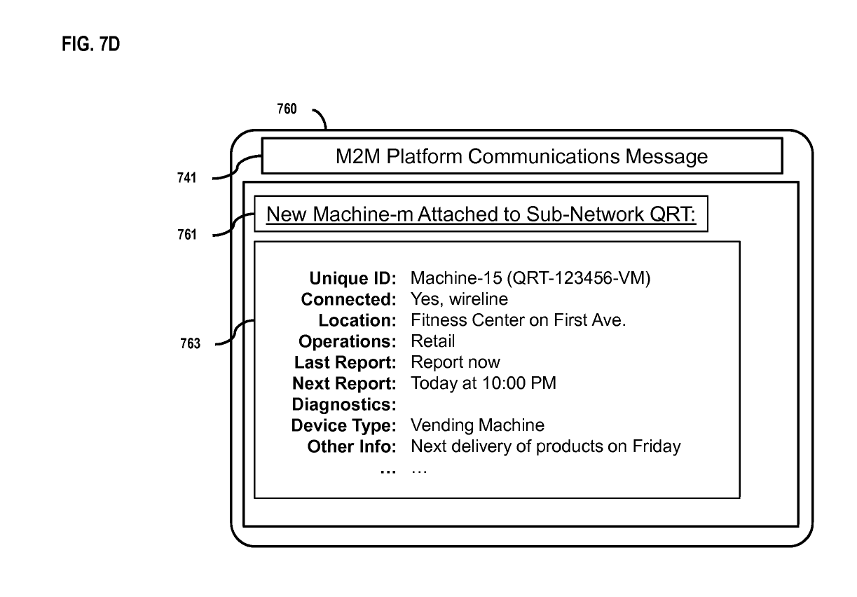

FIGS. 7A through 7D illustrate example communication messages in an M2M communications network, according to various embodiments.

FIG. 7A includes an illustration of a communication message 700 that includes information on a sub-network “XYZ” communications message 701. In one example, the message 701 may indicate status information 703 associated with an attached machine “machine-n.” In one embodiment, an aggregator associated with the sub-network “XYZ” may generate the message 700 and provide the information items included in the details 701. For example, the details 701 may include one or more information items 705, which may indicate a machine ID, a connectivity status, location information, machine operational information, and the like. In one embodiment, the machine ID is a unique ID that may be specified by an M2M platform or an aggregator associated with the sub-network that the machine is attached to. In one embodiment, the unique identifier may be based on one or more information items associated with the machine, the sub-network, an entity associated with the machine, a service associated with the machine, or a combination thereof. In various examples, information about a machine's serial number, Internet protocol (IP) address, a type of the machine, service/product associated with the machine, location of the machine, the sub-network or aggregator associated with the machine, an owner of the machine (e.g., an entity associated with the machine), or the like may be utilized in specifying, determining, or generating the unique ID for the machine. In one example, the M2M platform may determine or provide one or more portions of the information items that may be utilized by another element in the communications network to specify, determine, or generate the unique ID for the machine. In one embodiment, an M2M platform may analyze the information 705 to determine diagnostics associated with the machine associated with the communications message 700. For example, the diagnostics information indicates that the “parking meter” machine will need software updates and that the machine indicates a low battery.

FIG. 7B includes an illustration of a communication message 720 that includes information 721 on an M2M platform communications message, which may provide status information 723 that is associated with a “machine-n” (e.g., machine-1). In one embodiment, the M2M platform may provide the message to an aggregator of a sub-network that the machine-n is attached to and/or to one or more entities that may be associated with the machine-n or with the aggregator of the sub-network. Further, the M2M platform may indicate or initiate one or more actions based on the information items 725. For example, based on the diagnostics information in FIG. 7A, the M2M platform may request for the machine-n or its associated aggregator to provide a report (e.g., “Report now”) as well as indicating that one or more maintenance actions will be a “software update in 30 mins” and that the “low battery will be replaced tomorrow.” In various scenarios, an M2M platform may utilize the unique ID of a machine and status information to facilitate communications and prompt actions to address any issues that may be associated with a particular machine in the system.

FIG. 7C includes an illustration of a communication message 740, which includes an M2M communications message 741 indicating a request 743 to attach a new machine-m “machine-15” to a sub-network QRT. In various scenarios, the request may be initiated by an aggregator of a sub-network or an entity associated with the sub-network or the new machine-m. In one scenario, the request 743 may include one or more information items 745 associated with a machine ID, connectivity status, location, machine operations, diagnostics, device type, or the like. In this example, the new machine-m is not yet associated with a unique ID, wherein the M2M platform or an aggregator associated with the new machine-m may specify and associate a unique ID with the new machine-m. For example, FIG. 7D includes an illustration of a communication message 760 where a message element 761 indicates that the new machine-m is attached to a sub-network “QRT” where the information items 763 include a unique ID for the new machine-15 (e.g., “QRT-123456-VM”). Further, additional status information indicate that the new machine-15 is connected via a wireline connection, located at “Fitness Center on First Ave”, and other related information items.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

The exemplary techniques and systems presented herein enables determining, specifying, or associating a unique identifier with a machine in an M2M communications network. As an advantage, an M2M platform may be utilized to specify or cause a specifying of a unique identifier for a machine attached to a sub-network of an aggregator, wherein the machine and the aggregator comprise at least a portion of a machine-to-machine deployment. Additionally, the M2M platform may be utilized to associate or cause an associating of the unique identifier with a message directed to or originating from the machine via the aggregator, wherein the unique identifier is exposed beyond the sub-network for determining a connectivity status of the machine.

The processes described herein for facilitating an M2M platform may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

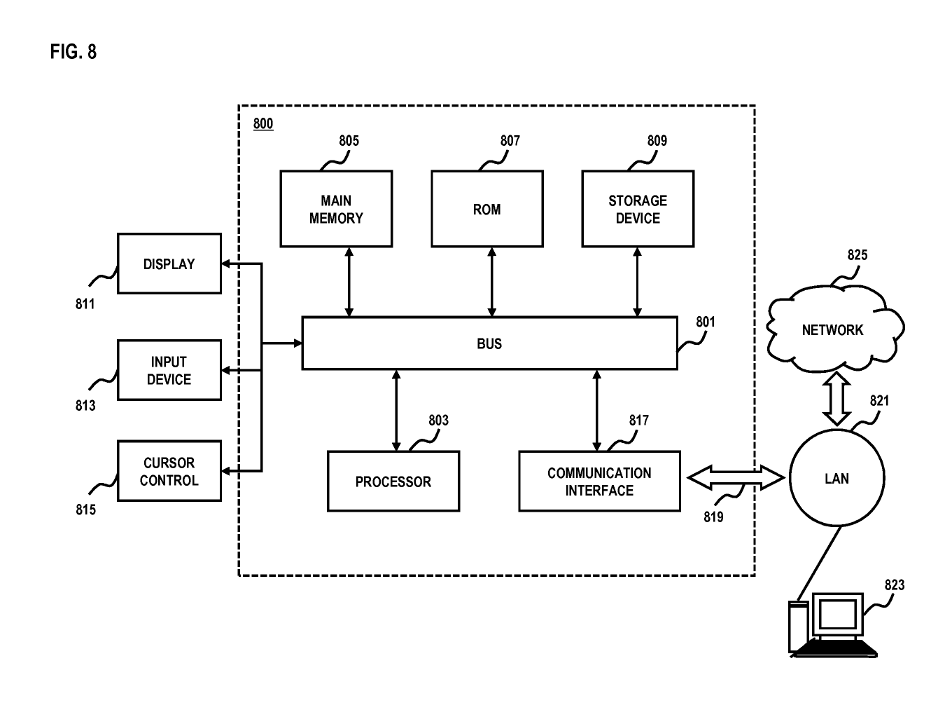

FIG. 8 illustrates computing hardware (e.g., computer system) upon which an embodiment according to the invention can be implemented. The computer system 800 includes a bus 801 or other communication mechanism for communicating information and a processor 803 coupled to the bus 801 for processing information. The computer system 800 also includes main memory 805, such as random access memory (RAM) or other dynamic storage device, coupled to the bus 801 for storing information and instructions to be executed by the processor 803. Main memory 805 also can be used for storing temporary variables or other intermediate information during execution of instructions by the processor 803. The computer system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. An input device 813, such as a keyboard including alphanumeric and other keys, is coupled to the bus 801 for communicating information and command selections to the processor 803. Another type of user input device is a cursor control 815, such as a mouse, a trackball, or cursor direction keys, for communicating direction information and command selections to the processor 803 and for controlling cursor movement on the display 811.

According to an embodiment of the invention, the processes described herein are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the invention. Thus, embodiments of the invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modem, or any other communication interface to provide a data communication connection to a corresponding type of communication line. As another example, communication interface 817 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted in FIG. 8, multiple communication interfaces can also be employed.

The network link 819 typically provides data communication through one or more networks to other data devices. For example, the network link 819 may provide a connection through local network 821 to a host computer 823, which has connectivity to a network 825 (e.g. a wide area network (WAN) or the global packet data communication network now commonly referred to as the “Internet”) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the invention through the network 825, the local network 821 and the communication interface 817. The processor 803 may execute the transmitted code while being received and/or store the code in the storage device 809, or other non-volatile storage for later execution. In this manner, the computer system 800 may obtain application code in the form of a carrier wave.

The term “computer-readable medium” as used herein refers to any medium that participates in providing instructions to the processor 803 for execution. Such a medium may take many forms, including but not limited to non-volatile media, volatile media, and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

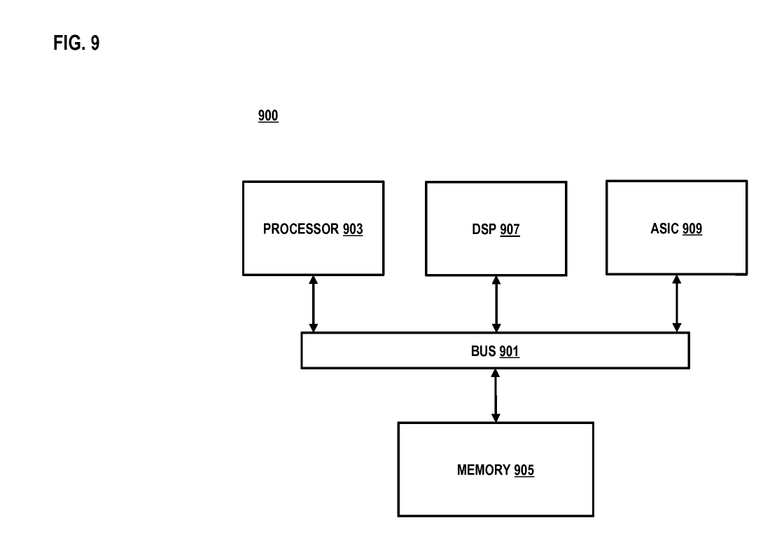

FIG. 9 illustrates a chip set 900 upon which an embodiment of the invention may be implemented. Chip set 900 is programmed to provide support for determining, specifying, or associating a unique identifier with a machine in an M2M communications network includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 900, or a portion thereof, constitutes a means for performing one or more steps of processes in FIGS. 4 through 6.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 905 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
specifying a unique identifier for a machine attached to a sub-network of an aggregator, wherein the machine and the aggregator comprise at least a portion of a machine-to-machine deployment; and
associating the unique identifier with a message directed to or originating from the machine via the aggregator,
wherein the unique identifier is exposed beyond the sub-network for determining a connectivity status of the machine.

2. A method of claim 1, further comprising:
generating a register of the machine, the unique identifier, one or more other machines, one or more other unique identifiers, or a combination thereof associated with the sub-network; and
updating the register based on network traffic associated with the sub-network or with an entity.

3. A method of claim 2, further comprising:
processing the network traffic to determine geographic location information, description information, service history information, or a combination thereof associated with the machine, the one or more other machines, or a combination thereof.

4. A method of claim 2, further comprising:
generating a query based on the unique identifier, the one or more other unique identifiers, or a combination thereof to determine the connectivity status of the machine, the one or more other machines, or a combination thereof.

5. A method of claim 2, further comprising:
determining predictive analytics or diagnostics information based on register data; and
initiating a process for managing a parameter or an operation at the machine, the one or more other machines, or a combination thereof based on the predictive analytics or the diagnostics information.

6. A method of claim 5, further comprising:
determining an unauthorized status associated with the machine, the one or more other machines, or a combination thereof based on the predictive analytics or the diagnostics information; and
updating the process or the register based on the unauthorized status.

7. A method of claim 1, further comprising:
determining a request for attaching a new machine to the sub-network;
authenticating an association of the new machine with the sub-network or with an entity associated with the sub-network; and
specifying a unique identifier for the new machine to attach to the sub-network.

8. A method of claim 1, wherein the unique identifier is based on one or more information items associated with the machine, the sub-network, an entity associated with the machine, a service associated with the machine, or a combination thereof.

9. An apparatus comprising:
a processor; and
a memory including computer program code for one or more programs,
the memory and the computer program code configured to, with the processor, cause the apparatus to perform at least the following:
specify a unique identifier for a machine attached to a sub-network of an aggregator, wherein the machine and the aggregator comprise at least a portion of a machine-to-machine deployment; and
associate the unique identifier with a message directed to or originating from the machine via the aggregator,
wherein the unique identifier is exposed beyond the sub-network for determining a connectivity status of the machine.

10. An apparatus of claim 9, wherein the apparatus is further caused to:
generate a register of the machine, the unique identifier, one or more other machines, one or more other unique identifiers, or a combination thereof associated with the sub-network; and
update the register based on network traffic associated with the sub-network or with an entity.

11. An apparatus of claim 10, wherein the apparatus is further caused to:
process the network traffic to determine geographic location information, description information, service history information, or a combination thereof associated with the machine, the one or more other machines, or a combination thereof.

12. An apparatus of claim 10, wherein the apparatus is further caused to:
generate a query based on the unique identifier, the one or more other unique identifiers, or a combination thereof to determine the connectivity status of the machine, the one or more other machines, or a combination thereof.

13. An apparatus of claim 10, wherein the apparatus is further caused to:
determine predictive analytics or diagnostics information based on register data; and
initiate a process for managing a parameter or an operation at the machine, the one or more other machines, or a combination thereof based on the predictive analytics or the diagnostics information.

14. An apparatus of claim 13, wherein the apparatus is further caused to:
determine an unauthorized status associated with the machine, the one or more other machines, or a combination thereof based on the predictive analytics or the diagnostics information; and
update the process or the register based on the unauthorized status.

15. An apparatus of claim 9, wherein the apparatus is further caused to:
determine a request for attaching a new machine to the sub-network;
authenticate an association of the new machine with the sub-network or with an entity associated with the sub-network; and
specify a unique identifier for the new machine to attach to the sub-network.

16. An apparatus of claim 9, wherein the unique identifier is based on one or more information items associated with the machine, the sub-network, an entity associated with the machine, a service associated with the machine, or a combination thereof.

17. A system comprising:
a machine-to-machine platform configured to specify a unique identifier for a machine attached to a sub-network of an aggregator, wherein the machine and the aggregator comprise at least a portion of a machine-to-machine deployment; and associate the unique identifier with a message directed to or originating from the machine via the aggregator, wherein the unique identifier is exposed beyond the sub-network for determining a connectivity status of the machine.

18. A system of claim 17, wherein the machine-to-machine platform is further configured to:
generate a register of the machine, the unique identifier, one or more other machines, one or more other unique identifiers, or a combination thereof associated with the sub-network; and
update the register based on network traffic associated with the sub-network or with an entity.

19. A system of claim 18, wherein the machine-to-machine platform is further configured to:
process the network traffic to determine geographic location information, description information, service history information, or a combination thereof associated with the machine, the one or more other machines, or a combination thereof.

20. A system of claim 18, wherein the machine-to-machine platform is further configured to:
determine predictive analytics or diagnostics information based on register data; and
initiate a process for managing a parameter or an operation at the machine, the one or more other machines, or a combination thereof based on the predictive analytics or the diagnostics information.
